(19) United States
(12) Patent Application Publication
(10) Pub. No.: US 2007/0206107 A1
(43) Pub. Date: Sep. 6, 2007

(54) Image capturing apparatus

(75) Inventor: Tetsu Wada, Kurokawa-gun (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/712,369

(22) Filed: Mar. 1, 2007

(30) Foreign Application Priority Data
Mar. 6, 2006 (JP) P2006-059947

(51) Int. Cl. H04N 5/335

(52) U.S. Cl. 348/311

(57) ABSTRACT

Photoelectric conversion elements 1 and VCCDs 2 are formed in a light reception region. A region is used to obtain an image having the maximum size is defined as a maximum light reception region 3. An image capturing apparatus includes a CPU 15 that performs control of reading signals only from the photoelectric conversion elements 1 disposed in a moving image capturing light reception region A; and a shading member 16b that, when a moving image is captured, shades at least a part of a region where formed are the photoelectric conversion elements 1 from which chargers are read to the VCCD 2 to which charges are also read from the photoelectric conversion elements 1 disposed in the moving image capturing light reception region A. The at least part of the region is the maximum light reception region 3 except the moving image capturing light reception region A.

### BACKGROUND OF THE INVENTION

1. Technical Field

The invention relates to an image capturing apparatus, which has a function of capturing a moving image and which includes a CCD-type solid-state imaging device.

2. Description of the Related Art

Usually, a function of capturing a moving image is installed in a digital camera for capturing a still image and recording the still image on a storage medium. When a moving image is captured with the digital camera, unlike photographing a still image, it is necessary to read signals from a solid-state imaging device at a high frame rate. Thus, when capturing a moving image, the digital camera uses only signals from photoelectric conversion elements, which are disposed in a narrow region around the center of the solid-state imaging device rather than all signals obtained from the solid-state imaging device so that high-speed reading can be implemented, for example, as shown in FIG. 5 of JP2004-289636A. This topic will be described with reference to FIGS. 7 and 8.

FIG. 7 is a schematic plan view of a general CCD-type solid-state imaging device.

The solid-state imaging device shown in FIG. 7 includes a large number of photoelectric conversion elements 1 disposed like a tetragonal lattice on a silicon substrate (in FIG. 7, only one photoelectric conversion element is denoted by numeral 1), a large number of vertical charge transfer sections (VCCDs) 2 for transferring charges read from the photoelectric conversion elements 1 in a vertical direction Y (in FIG. 7, only one vertical charge transfer section is denoted by numeral 2), and a horizontal charge transfer parts (HCCDs) 11a for transferring the charges transferred from the VCCDs 2 in a horizontal direction X orthogonal to the vertical direction Y.

The photoelectric conversion elements 1 are disposed as an array with n elements in the vertical direction and m elements in the horizontal direction (where n<m). The photoelectric conversion elements 1 contain photoelectric conversion elements (optical black (OB) elements) with a light reception surface being shaded for black level detection and/or smear correction. A region on the silicon substrate where the photoelectric conversion elements 1 and the VCCDs 2 are formed is called a light reception region 11. The OB elements are formed in the peripheral portion of the light reception region 11. Thus, the photoelectric conversion elements 1 except the OB elements in the light reception region 11 are photoelectric conversion elements used to obtain an image having the maximum size in the solid-state imaging device. A region 3 where the photoelectric conversion elements 1 except the OB elements in the light reception region 11 are formed will be hereinafter referred to as a “maximum light reception region 3”. A size of the maximum light reception region 3 can be expressed by the number of the photoelectric conversion elements 1 arranged in the X direction in the region 3 and the number of the photoelectric conversion elements 1 arranged in the Y direction in the region 3.

FIG. 8 is a schematic view for describing capturing of a moving image with the solid-state imaging device shown in FIG. 7. When a still image is captured, signals from all the photoelectric conversion elements 1 in the maximum light reception region 3 are used. However, when a moving image is captured, only signals obtained from a part of the photoelectric conversion elements 1 in the maximum light reception region 3 (which will be hereinafter also called “moving image capturing photoelectric conversion elements 1”) are used because it is necessary to read signals from the solid-state imaging device at a high frame rate, for example, 30 frames per second. Of the maximum light reception region 3, a region where the moving image capturing photoelectric conversion elements 1 are formed is called “moving image capturing light reception region A”. In the moving image capturing light reception region A, m/3 photoelectric conversion elements 1 (X direction)×n/3 photoelectric conversion elements 1 (Y direction), for example, are formed. When a moving image is captured, signals obtained from the photoelectric conversion elements 1 in regions B, C, D and E other than the moving image capturing light reception region A are discarded in reading. A size of the moving image capturing light reception region A can also be expressed by the number of the photoelectric conversion elements 1 arranged in the X direction in the region A and the number of the photoelectric conversion elements 1 arranged in the Y direction in the region A.

Light is also incident on the regions B, C, D and E, which are unnecessary for generating moving image data, other than the moving image capturing light reception region A at the time when a moving image is captured. The VCCDs 2 to which charges are read from the photoelectric conversion elements 1 disposed in the regions D and E are not common to the VCCDs 2 to which charges are read from the photoelectric conversion elements 1 disposed in the moving image capturing light reception region A. Therefore, if strong light is incident on the photoelectric conversion elements 1 disposed in the regions D and E, a smear does not occur. However, the VCCDs 2 to which charges are read from the photoelectric conversion elements 1 disposed in a part of the regions B and C are common to the VCCDs 2 from which charges are read from the photoelectric conversion elements 1 disposed in the moving image capturing light reception region A. Thus, if strong light is incident on the photoelectric conversion elements 1 disposed in a part of the regions B and C, a smear occurs. Although it is difficult to suppress occurrence of a smear caused by incidence of strong light on the photoelectric conversion elements 1 disposed in the moving image capturing light reception region A, it is considered that there is room for improvement in smear caused by the regions B and C.

### SUMMARY OF THE INVENTION

The invention provides an image capturing apparatus, which can suppress smear when capturing a moving image.

According to an aspect of the invention, an image capturing apparatus includes a CCD-type solid-state imaging device, a control unit and a shading unit. The solid-state imaging device includes a large number of photoelectric conversion elements, a plurality of first charge transfer sections, and a second charge transfer section. The first charge transfer sections transfer charges obtained from the large number of photoelectric conversion elements in a predetermined direction. The second charge transfer section transfers the charges, which are transferred from the first charge transfer sections, in a direction intersecting the predetermined direction. The large number of photoelectric conversion elements and the first charge transfer sections are formed in a light reception region. Of the light reception region, photoelectric conversion elements used to obtain an image having a maximum size are formed in a maximum light reception region. When a moving image is captured, the control unit performs control to read signals only from moving image capturing photoelectric conversion elements, which are a part of the photoelectric conversion elements disposed in the maximum light reception region. When the moving image is captured, the shading unit shades from light at least a part of photoelectric conversion elements except the moving image capturing photoelectric conversion elements disposed in the maximum light reception region, the at least part of the photoelectric conversion elements from which charges are read to a first charge transfer section common to a first charge transfer section to which charges are also read from the moving image capturing photoelectric conversion elements.

Also, a size of a region, which is defined between the second charge transfer section and a moving image capturing light reception region in which the moving image capturing photoelectric conversion elements are formed, may be equal to or larger than that of the moving image capturing light reception region. When the moving image is captured, the shading unit may shade from light at least a part of photoelectric conversion elements, which are disposed in the maximum light reception region between the second charge transfer section and the moving image capturing light reception region.

With the above configuration, the image capturing apparatus can suppress smear when capturing a moving image.

### BRIEF DESCRIPTION OF THE DRAWINGS

FIG. 1 is a schematic plan view to show the schematic configuration of a solid-state imaging device according to an embodiment of the invention.

FIG. 2 is a drawing to show the schematic configuration of a digital camera, which is an example of an image capturing apparatus having the photoelectric conversion elements shown in FIG. 1.

FIG. 3 is a drawing to show the attitude of the solid-state imaging device relative to the digital camera shown in FIG. 1.

FIG. 4 is a drawing to show a setting example of a moving image capturing light reception region A in the digital camera shown in FIG. 1.

FIG. 5 is a drawing to show the schematic configuration of a imaging optical system shown in FIG. 2.

FIG. 6 is a drawing to show another setting example of the moving image capturing light reception region A in the digital camera shown in FIG. 1.

FIG. 7 is a schematic plan view of a general CCD-type solid-state imaging device.

FIG. 8 is a view to schematically describe the case where a moving image is captured with the solid-state imaging device shown in FIG. 7.

### DETAILED DESCRIPTION OF EMBODIMENTS OF THE INVENTION

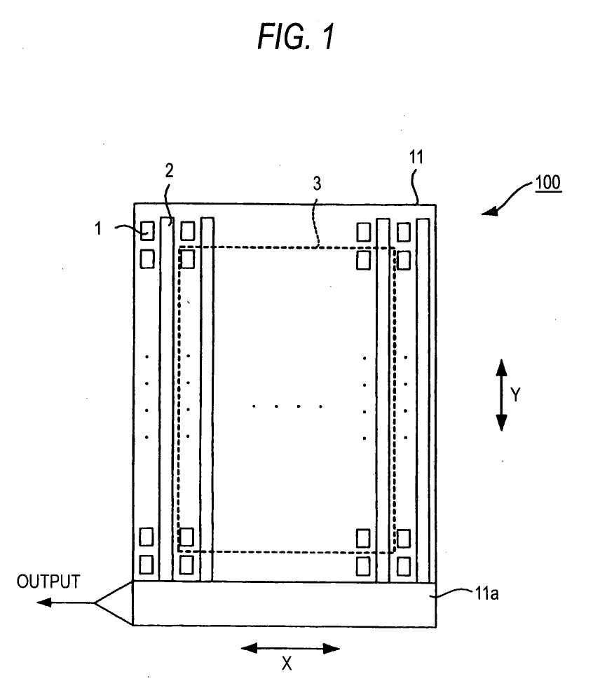

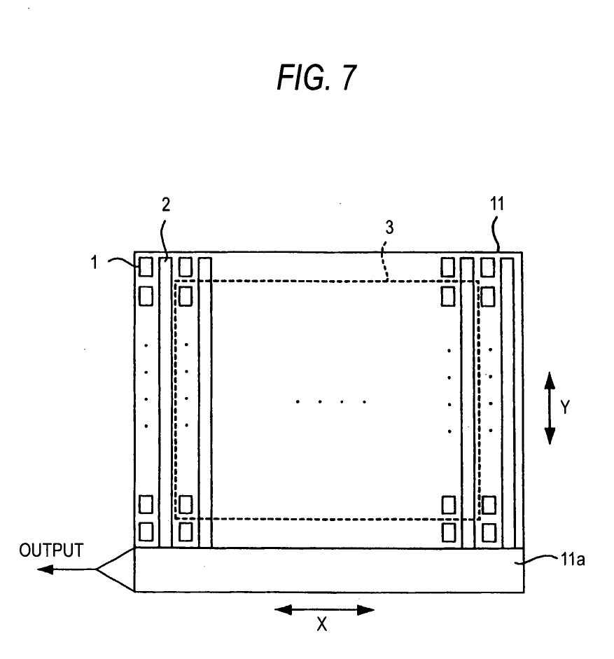

FIG. 1 is a schematic plan view to show the schematic configuration of a solid-state imaging device according to an embodiment of the invention. Components identical to those previously described with reference to FIG. 7 are denoted by the same reference numerals in FIG. 1.

A solid-state imaging device 100 shown in FIG. 1 is the same as the solid-state imaging device shown in FIG. 7 except that a relation between the number of photoelectric conversion elements 1 in the X direction, m, and the number of photoelectric conversion elements 1 in the Y direction, n, is n>m (vertically-long orientation).

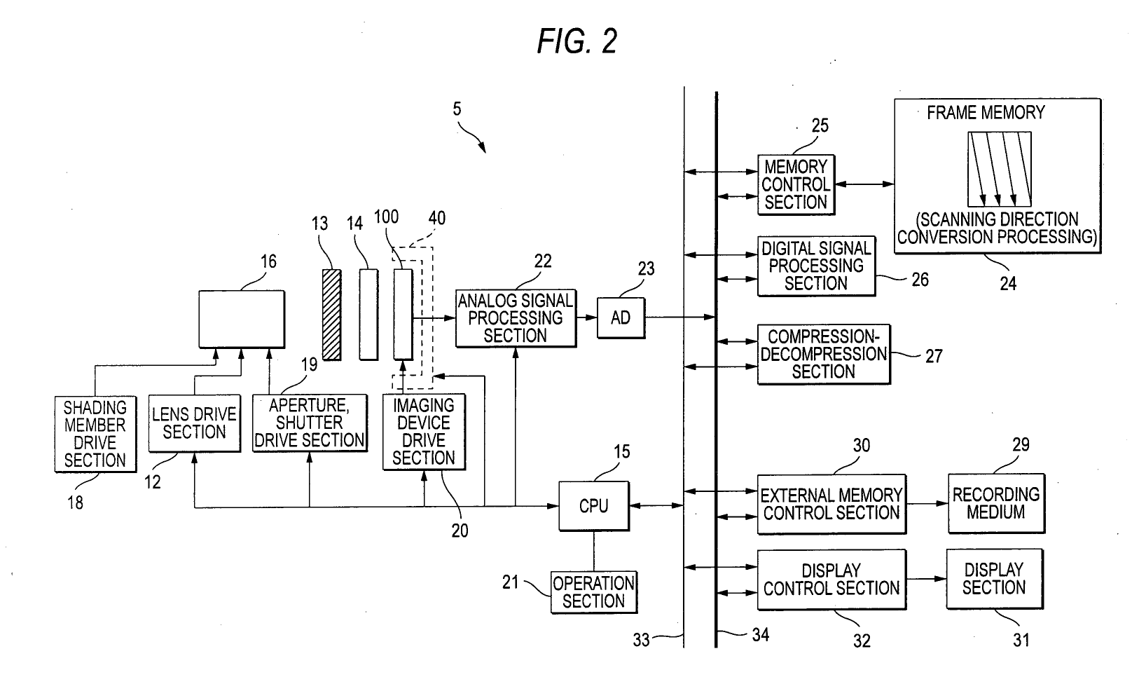

FIG. 2 is a drawing to show the schematic configuration of a digital camera, which is an example of an image capturing apparatus having the solid-state imaging device 100 shown in FIG. 1.

A digital camera 5 shown in FIG. 2 includes: an imaging optical system 16 containing an imaging lens 10 and an aperture 16a (described later); the solid-state imaging device 100 shown in FIG. 1 placed on a rotation table 40; and an infrared cut filter 13 and an optical low-pass filter 14, which are disposed between the imaging optical system 16 and the solid-state imaging device 100.

A CPU 15 for controlling the whole of the digital camera 5 controls a lens drive section 12 to adjust a position of the imaging lens 10 to a focus position and controls an aperture amount of the aperture 16a through a shutter drive section 19 to adjust so that the exposure value becomes an appropriate exposure value.

The CPU 15 drives the solid-state imaging device 100 through an imaging device drive section 20 to perform control of reading signals from the solid-state imaging device 100 and control of discarding signals read from photoelectric conversion elements 1, and causes the solid-state imaging device 100 to output a subject image captured through the imaging lens 10 as a color signal. When the CPU 15 performs the control of reading signals from the solid-state imaging device 100 and the control of discarding signals read from the solid-state imaging device 100, settings are made for the moving image capturing photoelectric conversion elements 1, which are used to capture a moving image, of the photoelectric conversion elements 1 disposed in a maximum light reception region 3 and the moving image capturing light reception region A where the moving image capturing photoelectric conversion elements 1 are formed.

Further, a user's command signal is input through an operation section 21 to the CPU 15, which then performs various types of control in accordance with the input command and also rotates the rotation table 40 for controlling the attitude of the solid-state imaging device 100 relative to the subject as described later depending on whether the user's command is a still image capturing command or a moving image capturing command.

An electric control system of the digital camera 5 includes: an analog signal processing section 22 connected to an output of the solid-state imaging device 100 and an A/D conversion circuit 23 for converting an RGB color signal output input from the analog signal processing section 22 into a digital signal. The CPU 15 controls the analog signal processing section 23 and the A/D conversion circuit 23.

The electric control system of the digital camera 5 further includes a memory control section 25 connected to a frame memory 24, a digital signal processing section 26 for performing offset processing, white balance correction processing and gamma correction processing, a compression-decompression section 27 for compressing a captured image to a JPEG image and decompressing a compressed image, an external memory control section 30 to which a detachable recording medium 29 is connected, and a display control section 32 to which a liquid crystal display section 31 installed on the rear side of the camera is connected. These components are connected by a control bus 33 and a data bus 34 and are controlled by a command output from the CPU 15.

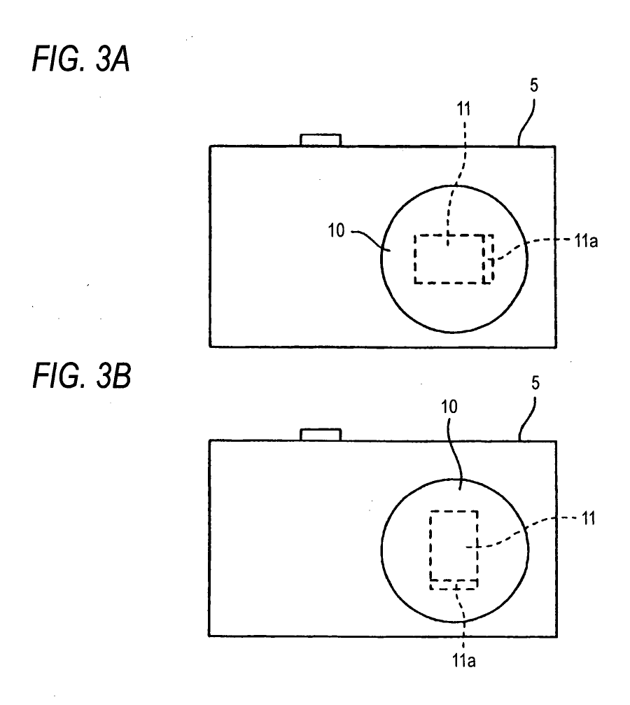

FIG. 3 is a drawing to show the attitude of the solid-state imaging device 100 relative to the digital camera 5 in FIG. 1. The solid-state imaging device 100 is placed in rear of the imaging lens 10 of the digital camera 5. The solid-state imaging device 100 is installed on the rotation table 40 as mentioned above.

For the user to capture a still image, the CPU 15 outputs a command to the rotation table 40 to fix the attitude of the solid-state imaging device 100 to a horizontally-long attitude relative to a horizontally-long casing of the digital camera 5 as shown in FIG. 3A.

A still image is captured in the state shown in FIG. 3A and signals obtained from the photoelectric conversion elements 1 disposed in the maximum light reception region 3 of the solid-state imaging device 100 are input to the frame memory 24 in FIG. 2. Then, the scanning direction is converted from the longitudinal direction (short side direction) into the lateral direction (long side direction). Accordingly, it is made possible to perform similar processing to that for signals read from a horizontally-long solid-state imaging device according to the related art.

When the user enters a command through the operation section 21 to capture a moving image, the CPU 15 outputs a rotation command to the rotation table 40 so as to place the attitude of the solid-state imaging device 100 in vertically-long orientation relative to the horizontally-long casing of the digital camera 5 as shown in FIG. 3B. Signals only from the moving image capturing photoelectric conversion elements 1 of the solid-state imaging device 100 placed in vertically-long orientation are read under the control of the CPU 15.

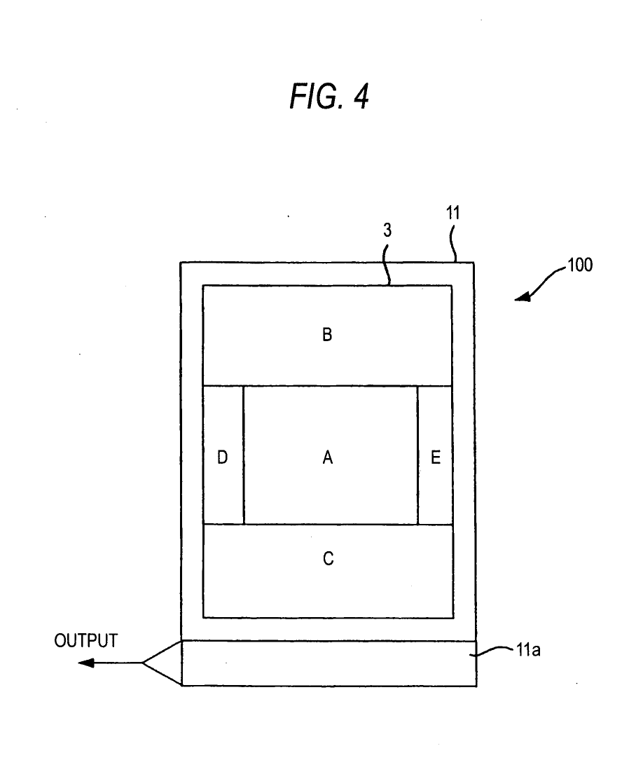

Accordingly, the moving image capturing light reception region A is set in a part of the maximum light reception region 3 of the solid-state imaging device 100 as shown in FIG. 4. Signals obtained from the moving image capturing photoelectric conversion elements 1 disposed in the moving image capturing light reception region A are output from the solid-state imaging device 100. Signals from the photoelectric conversion elements 1 disposed in the other regions B, C, D and E are discarded in reading.

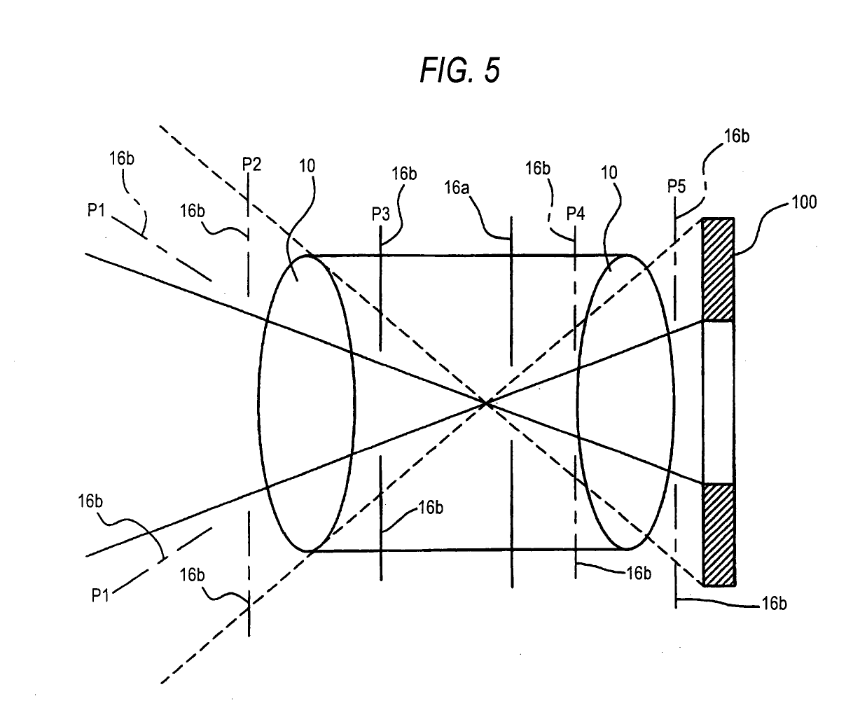

FIG. 5 is a drawing to show the schematic configuration of the imaging optical system 16 shown in FIG. 2.

The imaging optical system 16 includes two imaging lenses 10, the aperture 16a placed between the two imaging lenses 10, and a shading member 16b placed between the imaging lens 10 on the subject side and the aperture 16a. The solid-state imaging device 100 is placed behind the imaging lens 10. For simplicity of the description, the infrared cut filter 13 and the optical low-pass filter 14 placed between the imaging lens 10 and the solid-state imaging device 100 are not shown in FIG. 5.

The shading member 16b is made of metal or a synthetic resin and has like a thin sheet shape for blocking light. When a moving image is captured, the shading member 16b functions as a shading unit that shades from light at least a part of the photoelectric conversion elements 1 except the moving image capturing photoelectric conversion elements 1 disposed in the maximum light reception region 3, the at least a part of the photoelectric conversion elements 1 from which charges are read to the VCCD 2, which are common to the VCCD 2 to which charges are read from the moving image capturing photoelectric conversion elements 1. For example, if the moving image capturing light reception region A is set as shown in FIG. 4 at the time when a moving image is captured, the shading member 16b shades the regions B and C.

The position of the shading member 16b is controlled by a shading member drive section 18 shown in FIG. 2. The shading member drive section 18 is controlled by the CPU 15. The possible position of the shading member 16b is any of positions P1 to P5 shown in FIG. 5. Except at the time when a moving image is captured, the shading member 16b is retreated from the optical path by the shading member drive section 18 and does not shade the solid-state imaging device 100.

Since the shading member 16b shades the regions B and C shown in FIG. 4 at the time when a moving image is captured, light is not incident on the photoelectric conversion elements 1 - - - from which charges are read to the VCCDs 2, which are common to the VCCDs 2 to which charges are read from the moving image capturing photoelectric conversion elements 1 - - - of the photoelectric conversion elements 1 disposed in the regions B, C, D and E. Consequently, smear caused by unnecessary light incident on the light reception region 3 other than the moving image capturing light reception region A can be suppressed. Of the photoelectric conversion elements 1 disposed in the regions B and C, only a part of the photoelectric conversion elements 1 from which charges are read to the VCCDs 2 common to the VCCDs 2 to which charges read from the moving image capturing photoelectric conversion elements 1 may be shaded. Thereby, the smear suppression effect can be provided although it is smaller.

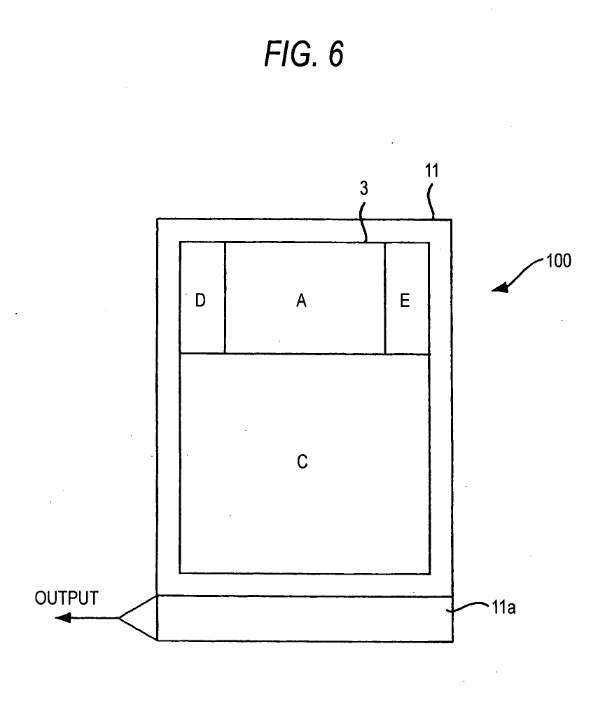

The moving image capturing light reception region A may also be set as shown in FIG. 6. In the example shown in FIG. 6, the size of the maximum light reception region 3 between the moving image capturing light reception region A and the HCCD 11a is equal to or larger than the size of the moving image capturing light reception region A. For example, it is assumed that the number of the moving image capturing photoelectric conversion elements 1 disposed in the moving image capturing light reception region A is 640 (X direction)×480 (Y direction). In this case, the position and the size of the moving image capturing light reception region A is set so that the number of the photoelectric conversion elements 1 disposed in the region between the moving image capturing light reception region A and the HCCD 11a becomes 640 or more (X direction)×480 or more (Y direction). The shading member drive section 18 controls the shading member 16b so that the shading member 16b shades the region C when a moving image is captured. In so doing, smear caused by unnecessary light incident on any other region than the moving image capturing light reception region A can also be suppressed. In such a case, the solid-state imaging device 100 has a similar configuration to that of a solid-state imaging device of frame interline type. Thus, driving similar to that for the solid-state imaging device of frame interline type may be applied to the solid-state imaging device 100 by the imaging device drive section 20, whereby a smear can be more suppressed.

When the moving image capturing light reception region A is set as shown in FIG. 6, if at least the photoelectric conversion elements 1 disposed in the maximum light reception region 3 between the moving image capturing light reception region A and the HCCD 11a are shaded, similar driving to that for the solid-state imaging device of frame interline type (FIT) can be applied.

Next, advantages provided by placing the solid-state imaging device 100 in the attitude as shown in FIG. 3B at the time when a moving image is captured will be described.

If, for example, 4,000 (X direction)×3,000 (Y direction) photoelectric conversion elements 1 exist in the maximum light reception region 3 of the solid-state imaging device 100 and 2,000 (X direction)×1,125 (Y direction) photoelectric conversion elements 1 exist in the moving image capturing light reception region A, the number of the photoelectric conversion elements 1 in the X direction in the regions D and E to which discarding of read signals is applied becomes 4,000−2,000=2,000.

The charges read from the regions B and C can be discarded to the silicon substrate side of the solid-state imaging device 100 at the discard point provided in a connection part between the VCCD 2 and the HCCD 11a, for example. Thus, high-speed discarding of read signals can be achieved. In contrast, if the charges read from the regions D and E are discarded at the discard point in a similar manner, the charges read from the moving image capturing light reception region A are also discarded together. Then, the charges read from the regions D and E can be discarded only after they are transferred from the VCCD 2 to the HCCD 11a and are transferred through the HCCD 11a. Thus, most of the time required for discarding unnecessary charges depends largely on the number of the photoelectric conversion elements 1 disposed in the regions D and E in the direction along the HCCD 11a.

If, for example, 3,000 (X direction)×4,000 (Y direction) photoelectric conversion elements 1 exist in the maximum light reception region 3 of the solid-state imaging device 100 and 2,000 (X direction)×1,125 (Y direction) photoelectric conversion elements 1 exist in the moving image capturing light reception region A, the number of the photoelectric conversion elements 1 in the X direction in the regions D and E to which discarding of read signals is applied becomes 3,000−2,000=1,000.

That is, when the solid-state imaging device 100 is placed in vertically-long orientation, unnecessary charges can be read and discarded at higher speed than that in the case where the solid-state imaging device 100 is placed in horizontally-long orientation. Surplus time may be used to read signals from the moving image capturing light reception region A. Thus, moving image data can be read at a high frame rate even from the high-resolution solid-state imaging device 100 and capturing of a high-resolution moving image is facilitated.

In the description given above, the solid-state imaging device 100 is placed in vertically-long orientation, which is not general, and is rotated between the time when a moving image is captured and the time when a solid image is captured. However, in a digital camera according to the related art having a solid-state imaging device disposed in horizontally-long orientation as shown in FIG. 7, smear can also be suppressed by providing the shading unit described above.

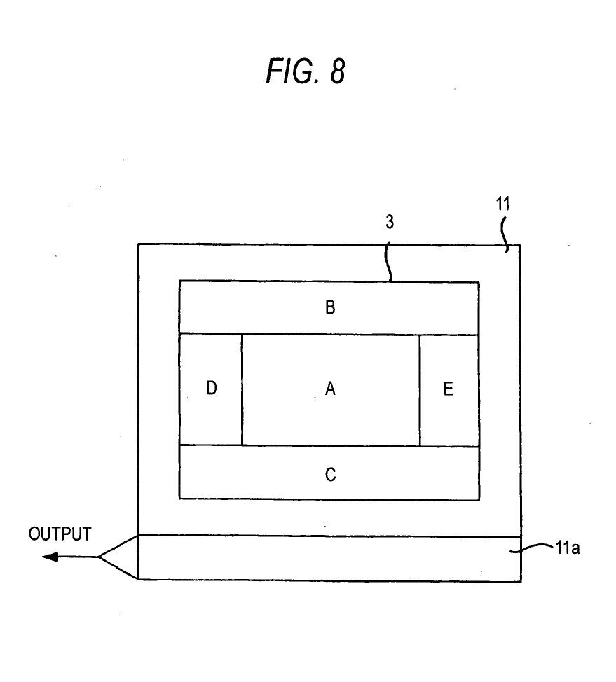

That is, an image capturing apparatus having a solid-state imaging device having the configuration as shown in FIG. 8 may be provided with the shading unit that, when a moving image is captured, shades from light at least a part of the photoelectric conversion elements 1 from which charges read to the VCCDs 2 common to the VCCDs 2 to which charges are read from the moving image capturing photoelectric conversion elements 1 the at least part of the photoelectric conversion elements being disposed in the regions B and C.

In the image capturing apparatus having the solid-state imaging device having the configuration shown in FIG. 8, the size of the maximum light reception region 3 between the moving image capturing light reception region A and the HCCD 11a may be set so as to be equal to or large than the size of the moving image capturing light reception region A, and the shading unit may shade from light at least the photoelectric conversion elements 1 disposed in the maximum light reception region 3 between the moving image capturing light reception region A and the HCCD 11a when a moving image is captured. In this case, similar driving to that for the solid-state imaging device of FIT type can be applied.

The solid-state imaging device 100 is placed in the attitude as shown in FIG. 3B at the time when a moving image is captured, the following advantages can also be achieved.

Let consider the following first and second configurations for comparison. In the first configuration, 2,000 (X direction)×3,000 (Y direction) photoelectric conversion elements 1 exist in the maximum light reception region 3 of the solid-state imaging device 100, and 1,000 (X direction)×1,500 (Y direction) photoelectric conversion elements 1 exist in the moving image capturing light reception region A. On the other hand, in the second configuration, 3,000 (X direction)×2,000 (Y direction) photoelectric conversion elements 1 exist in the maximum light reception region 3 of the solid-state imaging device 100, and 1,000 (X direction)×1,500 (Y direction) photoelectric conversion elements 1 exist in the moving image capturing light reception region A.

In the second configuration, only 2,000−1,500=500 photoelectric conversion elements 1 in the Y direction exist in the maximum light reception region 3 between the moving image capturing light reception region A and the HCCD 11a. Thus, the size of the maximum light reception region 3 between the moving image capturing light reception region A and the HCCD 11a cannot be set so as to be equal to or large than the size of the moving image capturing light reception region A. In contrast, with the first configuration, 3,000−1,500=1,500 photoelectric conversion elements 1 in the Y direction exist in the maximum light reception region 3 between the moving image capturing light reception region A and the HCCD 11a. Thus, the size of the maximum light reception region 3 between the moving image capturing light reception region A and the HCCD 11a can be set to be equal to the size of the moving image capturing light reception region A. Thus, the solid-state imaging device 100 is placed in vertically-long orientation, so that it is possible to apply driving similar to that for the solid-state imaging device of frame interline type, and to improve the smear suppression effect.

In the embodiment described above, the solid-state imaging device 100 is placed on the rotation table 40 of an attitude change unit, the rotation table 40 is rotated on the optical center depending on whether a still image or a moving image is to be captured, and the solid-state imaging device 100 is placed in vertically-long orientation at the time when a moving image is captured. However, the rotation table 40 may have any configuration. A rotation table for 90-degree rotating and moving the attitude of the whole optical system containing the solid-state imaging device 100 with a position out of the optical center as the center may be used. Further, the attitude of the solid-state imaging device 100 may be fixed relative to the digital camera 5. In this case, instead of providing the rotation table 40, when the attitude of the solid-state imaging device 100 is not placed in vertically-long orientation at the time when a moving image is captured, for example, a warning may be notified to a user by means of a sensor for detecting the gravity direction.

What is claimed is:

1. An image capturing apparatus comprising:
a CCD-type solid-state imaging device comprising:
a large number of photoelectric conversion elements;
a plurality of first charge transfer sections that transfer charges obtained from the large number of photoelectric conversion elements in a predetermined direction; and
a second charge transfer section that transfers the charges, which are transferred from the first charge transfer sections, in a direction intersecting the predetermined direction, wherein:
the large number of photoelectric conversion elements and the first charge transfer sections are formed in a light reception region, and
of the light reception region, photoelectric conversion elements used to obtain an image having a maximum size are formed in a maximum light reception region;
a control unit that, when a moving image is captured, performs control to read signals only from moving image capturing photoelectric conversion elements, which are a part of the photoelectric conversion elements disposed in the maximum light reception region; and
a shading unit that, when the moving image is captured, shades from light at least a part of photoelectric conversion elements except the moving image capturing photoelectric conversion elements disposed in the maximum light reception region, the at least part of the photoelectric conversion elements from which charges are read to a first charge transfer section common to a first charge transfer section to which charges are also read from the moving image capturing photoelectric conversion elements.

2. The apparatus according to claim 1, wherein:
a size of a region, which is defined between the second charge transfer section and a moving image capturing light reception region in which the moving image capturing photoelectric conversion elements are formed, is equal to or larger than that of the moving image capturing light reception region, and
when the moving image is captured, the shading unit shades from light at least a part of photoelectric conversion elements, which are disposed in the maximum light reception region between the second charge transfer section and the moving image capturing light reception region.
